(19) United States
(12) Patent Application Publication
(10) Pub. No.: US 2025/0246628 A1
(43) Pub. Date: Jul. 31, 2025

(54) CATHODE INTER-CONNECT WITH POLYMER-BASED SCHEMES

(71) Applicant: Enovix Corporation, Fremont, CA (US)

(72) Inventors: Yousra El Ajjouri, Fremont, CA (US); Niteen G. Jadhav, Newark, CA (US); Mayuresh Keskar, Fremont, CA (US); Doron Gal, Sunnyvale, CA (US); Dmytro Poplavskyy, San Jose, CA (US); Michael J. Armstrong, New Braunfels, TX (US); Daniel J. Noelle, Mountain View, CA (US); Miles A.M. Kool, San Francisco, CA (US)

(21) Appl. No.: 18/424,239

(22) Filed: Jan. 26, 2024

(51) Int. Cl. H01M 4/62; H01M 4/02; H01M 4/04; H01M 4/70; H01M 10/00

(52) U.S. Cl. CPC H01M 4/622; H01M 4/0404; H01M 4/624; H01M 4/70; H01M 10/00; H01M 2004/028

(57) ABSTRACT

Methods and devices are provided herein for connecting a plurality of cathode structures to a cathode busbar within an electrode assembly of a secondary battery. Each cathode structure includes a cathode active material layer and a current collector, wherein the cathode current collector has an end portion that extends beyond the cathode active material layer. The end portions of the cathode structures are attached to the cathode busbar via two adhesive polymer strips that enable strong mechanical and electrical connections between the cathode structures and the cathode busbar.

### BACKGROUND

The present disclosure relates to methods and structures such as electrode assemblies including current limiters for use in energy storage devices such as secondary batteries, to energy storage devices employing such structures, and to methods for manufacturing such structures and energy devices.

### SUMMARY

Some energy storage devices, such as lithium-based secondary batteries, comprise a plurality of cells that each include an anode structure and a cathode structure separated by a separator structure. Within each cell, the anode structure and cathode structure are respectively attached to anode and cathode busbars. The busbars connect the cells together, and connect the cells to the positive and negative terminals of the energy storage device to enable a user to make use of the stored energy.

One approach for connecting a cathode structure to the cathode busbar includes using a “D-slot” or opening in the busbar. During assembly, the cathode structure is extended through the opening in the cathode busbar, and then bent over to contact the outer surface of the cathode busbar opposite the main body of the cathode structure. However, this technique for connecting a cathode structure to the cathode busbar brings certain challenges. Given the small scale of the structures, the cathode structure and/or cathode busbar openings may be broken, torn, or otherwise deformed during manufacturing. Additionally, during assembly, it may be difficult to align and insert the cathode structures into the cathode busbar openings, particularly without causing further deformation or damage to the cathode structures and/or cathode openings. Other approaches, such as laser welding, bring other drawbacks such as increased complexity and increased expense due to the equipment required.

Furthermore, some approaches to making structural and electrical connections between various structures within an energy storage device may be applicable only to a subset of the device's structures. For example, an adhesive may be used to attach an anode structure to an anode busbar, but the adhesive material may be limited to only those materials compatible with the anode structure and anode busbar. The same adhesive may operate compatibly with the anode material, but may degrade or break down if used to affix a cathode structure to a cathode busbar.

In another approach, an adhesive may be applied to the full surface of the cathode structure that is in contact with the cathode busbar. However, this approach may require a greater amount of adhesive, may require higher pressures (e.g., due to the larger surface area), and may cause non-uniformity of the resulting connection due to material leaking or squeezing out from the sides of the connection between the cathode structure and the cathode busbar when pressure is applied.

Accordingly, methods and structures are disclosed herein for providing a structural connection between a cathode structure and a cathode busbar within an energy storage device. An example electrode assembly includes a plurality of unit cells stacked in a stacking direction, each having an anode structure, a cathode structure, and a separator structure. The cathode structure comprises a cathode current collector and a cathode active material layer, and the cathode structure extends in the longitudinal direction perpendicular to the stacking direction. An end portion of each cathode current collector of the plurality of cells extends beyond the cathode active material and the separator structure in the longitudinal direction. The electrode assembly also includes first and second adhesive polymer strips attached to the end portions of the cathode current collectors, and a cathode busbar attached to the end portions of the cathode current collectors through the first and second adhesive polymer strips.

This structure enables a mechanical and electrical connection between the cathode structure and the cathode busbar without requiring d-slots, thereby reducing the risks and issues associated with deformation of the d-slots during manufacturing and assembly. Additionally, the disclosed methods and structures enable the mechanical and electrical connection between the cathode structure and the cathode busbar using materials suitable for use with the cathode materials. Furthermore, the use of first and second adhesive strips, rather than applying the adhesive to the entire surface of the cathode structure that is in contact with the cathode busbar, enables for a mechanical and electrical connection using less adhesive material. It also enables for a more uniform connection, the use of lower pressures, and reduced leaking of adhesive out the sides of the connection when pressure is applied.

In some examples, the first and second adhesive polymer strips each comprise a neat polymer, without any suspended conductive material. In some examples, the first and second adhesive polymer strips may be thermoplastic adhesives or thermosets. In still other examples, the first and second adhesive polymer strips may be separated from each other in a direction perpendicular to the stacking direction of the cells, and perpendicular to the longitudinal direction of the cathode structures. The section of the cathode structure between the first and second adhesive polymer strips may be the middle section, which may be attached directly to the cathode busbar (i.e., not through the adhesive), such as by welding.

In some examples, the first and second adhesive polymer strips may each include a base polymer and a conductive filler. The conductive filler may be aluminum, titanium, titanium nitride, carbon, stainless steel, or a noble metal. Additionally, the shape of the conductive filler may be spheres, flakes, fibers, hollow coated particles, solid coated particles, or a conductive mesh.

Furthermore, in some examples the first and second adhesive polymer strips may function as a current limiting mechanism within the energy storage device. This may be referred to as a BrakeFlow™ mechanism (trademark owned by Enovix Corporation), which may be used to prevent thermal runaway in batteries; battery packs; battery storage devices, and battery cells. Using an energy storage device like those described herein includes the risk that energy is released in an undesirable or uncontrolled manner though accident, abuse, exposure to extreme conditions, or the like. When the current flow between the cathode current collectors and the cathode busbar increases beyond a threshold level (e.g., due to accident, abuse, etc.), the first and second adhesive polymer strips may break down or change their conductive properties, thereby reducing or partially eliminating the electrical connection. In turn, the reduced electrical connection acts to reduce further release of energy.

### BRIEF DESCRIPTION OF THE DRAWINGS

The present disclosure, in accordance with one or more various implementations, is described in detail with reference to the following drawings. The drawings are provided for purposes of illustration only and merely depict typical or example implementations. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 is a simplified diagram of an example electrode assembly for cycling between a charged state and a discharged state in a secondary battery, in accordance with some implementations of the disclosure.

FIG. 2 is a simplified diagram of another example electrode assembly for cycling between a charged state and a discharged state in a secondary battery, in accordance with some implementations of the disclosure.

FIG. 3A is a perspective view of an electrode structure and two adhesive polymer strips, in accordance with some implementations of the disclosure.

FIG. 3B is a perspective view of the electrode structure of FIG. 3A affixed to an electrode busbar via the two adhesive polymer strips, in accordance with some implementations of the disclosure.

FIG. 4A is an end view of a plurality of electrode structures affixed to an electrode busbar via two adhesive polymer strips, in accordance with some implementations of the disclosure.

FIG. 4B is a side view of the plurality of electrode structures affixed to the electrode busbar via the two adhesive polymer strips of FIG. 4A, in accordance with some implementations of the disclosure.

FIG. 5 is a perspective view of an end of a stacked cell including a plurality of electrode structures affixed to an electrode busbar via adhesive polymer strips, in accordance with some implementations of the disclosure.

FIG. 6 is a perspective view of an end of a stacked cell including a plurality of electrode structures affixed to an electrode busbar via adhesive polymer strips and via welds, in accordance with some implementations of the disclosure.

FIG. 7 illustrates a closeup view of the tabs of a plurality of electrode structures before being affixed to an electrode busbar, in accordance with some implementations of the disclosure.

FIG. 8 is an illustrative flowchart of a process for assembling an electrode assembly, in accordance with some implementations of the disclosure.

### DETAILED DESCRIPTION

As noted above, implementations of the present disclosure relate to secondary batteries, the structures that make up the secondary batteries, and the methods and processes for manufacturing the structures and batteries. As used herein, the term “anode” used in the context of a secondary battery may refer to the negative electrode in a secondary battery. “Anode material” or “anodically active” as used herein may refer to a material or materials suitable for use as the negative electrode of a secondary battery. The term “cathode” as used herein in the context of a secondary battery may refer to the positive electrode in a secondary battery. “Cathode material” or “cathodically active” as used herein may refer to a material or materials suitable for use as the positive electrode of a secondary battery.

In some implementations described herein, the term “electrode” may be used to refer to either the anode or the cathode, and the term “counter-electrode” may refer to the other or opposite. For the sake of explanation, implementations may be described in terms of “electrode” and “counter-electrode.” It should be appreciated that in these implementations, the term electrode may be replaced by the term anode while the term counter-electrode may be replaced by the term cathode. Alternatively, in these implementations, the term electrode may be replaced by the term cathode while the term counter-electrode may be replaced by the term anode.

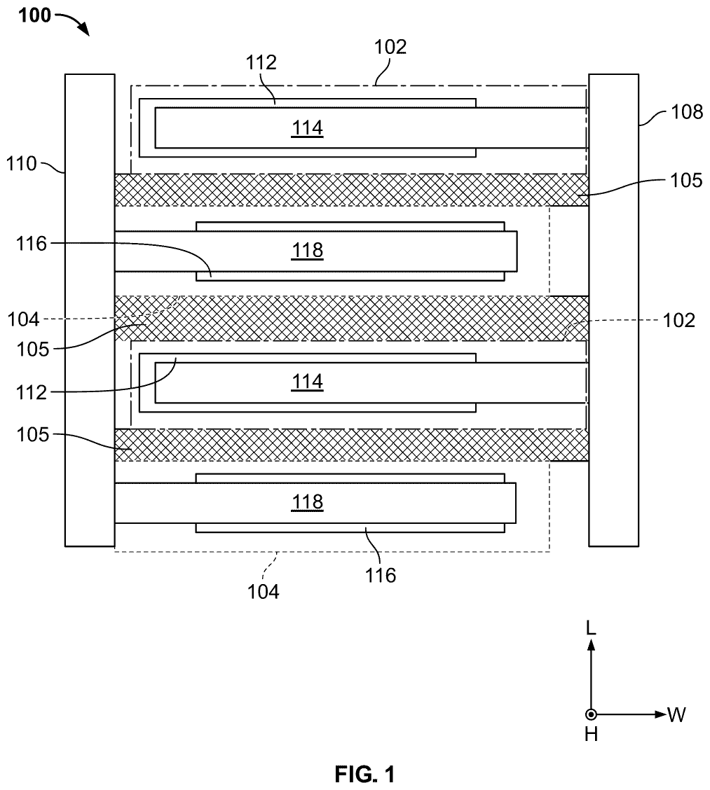

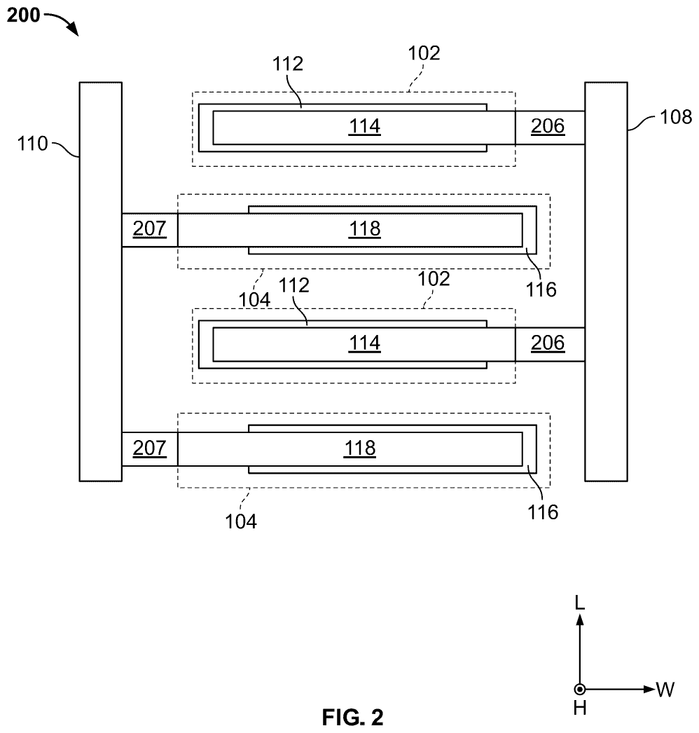

FIGS. 1 and 2 illustrate simplified diagrams of a first example electrode assembly 100 and a second example electrode assembly 200 for cycling between a charged state and a discharged state in a battery. FIG. 1 illustrates an electrode assembly 100, wherein the electrode and counter-electrode structure 102 and 104 are connected to the electrode and counter-electrode busbars 108 and 110 directly, without a current limiter positioned in between. FIG. 2 illustrates an electrode assembly 200, which may be similar or identical to electrode structure 100 in many respects, but which illustrates the electrode and counter-electrode structures 102 and 104 connected to the electrode and counter-electrode busbars 108 and 110 via current limiters 206 and 207, respectively. Additionally, in FIG. 2, the separator material 105 has been removed to avoid over complicating the illustration. It should be appreciated, however, that the electrode assembly 200 may include a separator material similar or identical to that shown in FIG. 1, positioned between each pair of electrode and counter-electrode structures 102 and 104.

FIGS. 1 and 2 illustrate electrode assemblies 100 and 200 each having a population of electrode structures 102 and a population of counter-electrode structures 104, an electrode busbar 108, and a counter-electrode busbar 110. Electrode assembly 100 is further illustrated including a population of separator structures 105. Electrode assembly 200 is further illustrated including current limiters 206 and 207. The example implementations shown in FIGS. 1 and 2 are electrode assemblies suitable for use in a three-dimensional secondary battery, in which the electrode structures 102 and counter-electrode structures 104 each extend primarily along a width W (or longitudinal direction) and height H of the assembly, and are separated from each other along a length L (or stacking direction). In other implementations, the electrode assemblies 100 and/or 200 may be for use in a laminar secondary battery.

A voltage difference V exists between adjacent electrode structures 102 and counter-electrode structures 104, which adjacent pairs may be considered a unit cell. Each unit cell has a capacity C determined by the makeup and configuration of the electrode structures 102 and counter-electrode structures 104. In an example implementation, each unit cell may produce a voltage difference of about 4.35 volts. In other implementations, each unit cell has a voltage difference somewhere in the range of about 0.5-5.0 volts, or any other suitable voltage. During cycling between charged and discharged states, the voltage may vary, for example, between about 2.5 volts and about 4.35 volts. The capacity C of a unit cell in an example implementation may be about 25 mAh. In other implementations, the capacity C of a unit cell may be about 50 mAh, less than 50 mAh, or any other suitable capacity. In some implementations, the capacity C of a unit cell may be up to about 500 mAh.

In the illustrated implementations of FIGS. 1 and 2, the electrode structures 102 and counter-electrode structures 104 are generally rectangular and arranged in an interdigitated structure. That is, the electrode structures 102 and counter-electrode structures 104 extend from opposite electrode and counter-electrode busbars 108, 110 and alternate along the stacking direction L. In other implementations, other shapes and arrangements of the electrode structures 102 and counter-electrode structures 104 may be used. For example, the electrode assemblies 100 and/or 200 (and the batteries within which they are included) may have any of the shapes and/or arrangements described or shown in U.S. Pat. No. 9,166,230, which is hereby incorporated by reference in its entirety.

Each member of the population of electrode structures 102 includes an electrode active material 112 and an electrode current collector 114. In FIG. 1, the electrode structures 102 are electrically connected in parallel to the electrode busbar 108 without a current limiter in between. In FIG. 2, the electrode structures 102 are electrically connected in parallel to the electrode busbar 108 via current limiters 206. The electrode structures 102 may be anodic or cathodic, but all of the electrode structures 102 in the population are of the same type (anodic or cathodic) in the example implementations shown in FIGS. 1 and 2. In some other implementations, the electrode structures 102 may include anodic and cathodic structures. Each member of the population of counter-electrode structures 104 includes a counter-electrode active material 116 and a counter-electrode current collector 118. In FIG. 1, the counter-electrode structures 104 are electrically connected in parallel to the counter-electrode busbar 110, without a current limiter in between. In FIG. 2, the counter-electrode structures 104 are electrically connected in parallel to the counter-electrode busbar 110 via current limiters 207. The counter-electrode structures 104 are all of the same type (anodic or cathodic) in the example implementations of FIGS. 1 and 2, and are of the opposite type to the electrode structures 104. In some other implementations, the counter-electrode structures 102 may include anodic and cathodic structures.

Although only two electrode structures 102 and two counter-electrode structures 104 are shown in FIGS. 1 and 2, the electrode assemblies 100 and/or 200 may have any number of electrode structures 102 and counter-electrode structures 104. The populations of electrode structures 102 and counter-electrode structures 104 will generally include the same number of members, but may include different numbers of electrode structures 102 and counter-electrode structures 104 in some implementations. For example, some implementations may begin and end with the same electrode structure 102 or counter-electrode structure, resulting in one more electrode structure 102 or counter-electrode structure. In some implementations, the populations of electrode structures 102 and counter-electrode structures 104 include at least twenty members each. Some implementations include populations of electrode structures 102 and counter-electrode structures 104 having about 10 members each, between 10 and 25 members each, between 25 and 250 members each, between 25 and 150 members each, between 50 and 150 members each, or up to 500 members each. In some implementations, the electrode structures 102 or the counter electrode structures 104 do not include an active material when discharged, and only the other of the counter electrode structures 104 or the electrode structures 102 includes an active material when discharged.

The cathodic type of the electrode structure 102 or the counter-electrode structure 104 includes a current collector 114 or 118 that is a cathode current collector. The cathode current collector material may comprise aluminum, nickel, cobalt, titanium, tungsten, carbon, chromium, gold, NiP, palladium, platinum, rhodium, ruthenium, silicon, alloys thereof, or any other material suitable for use as a cathode current collector layer. In some implementations, the cathode current collector may have an electrical conductivity of at least about 103 Siemens/cm. However, it should be appreciated that in other implementations, the cathode current collector may have an electrical conductivity that is greater or less than 103 Siemens/cm. The anodic type of the electrode structure 102 or the counter-electrode structure 104 may include a current collector 114 or 118 that is an anode current collector. The anode current collector may comprise a conductive material such as copper, carbon, nickel, stainless steel, cobalt, titanium, and tungsten, alloys thereof, or any other material suitable as an anode current collector layer.

The cathodic type of the electrode structure 102 or the counter-electrode structure 104 may include an active material 112 or 116 that is a cathodically active material. The cathodically active material may be an intercalation-type chemistry active material, a conversion chemistry active material, and/or a combination thereof. Exemplary conversion chemistry materials may include, but are not limited to, S (or Li₂S in the lithiated state), LiF, Fe, Cu, Ni, FeF₂, FeO_{d}F_{3.2d}, FeF₃, CoF₃, CoF₂, CuF₂, NiF₂, where 0≤d≤0.5, and the like.

Example cathodically active materials may also include any of a wide range of intercalation type cathodically active materials. For example, for a lithium-ion battery, the cathodically active material may comprise a cathodically active material selected from transition metal oxides, transition metal sulfides, transition metal nitrides, lithium-transition metal oxides, lithium-transition metal sulfides, and lithium-transition metal nitrides may be selectively used. The transition metal elements of these transition metal oxides, transition metal sulfides, and transition metal nitrides can include metal elements having a d-shell or f-shell. Specific examples of such metal element are Sc, Y, lanthanoids, actinoids, Ti, Zr, Hf, V, Nb, Ta, Cr, Mo, W, Mn, Tc, Re, Fe, Ru, Os, Co, Rh, Ir, Ni, Pb, Pt, Cu, Ag, and Au. Additional cathode active materials include LiCoO₂, LiNi_{0.5}Mn_{1.5}O₄, Li(NiₓCo_{y}Al_{z})O₂, LiFePO₄, Li₂MnO₄, V₂O₅, molybdenum oxysulfides, phosphates, silicates, vanadates, sulfur, sulfur compounds, oxygen (air), Li(NiₓMn_{y}Co_{z})O₂, and combinations thereof.

In some implementations, the cathodically active material may have a thickness of at least 20 microns (20 μm). For example, in one implementation, the cathodically active material will have a thickness of at least 40 microns (40 μm). By way of further example, in one such implementation, the cathodically active material will have a thickness of at least 60 microns (60 μm). By way of further example, in one such implementation, the cathodically active material will have a thickness of at least 100 microns (100 μm). In some implementations, however, the cathodically active material will have a thickness of less than 90 microns (90 μm) or less than 70 microns (70 μm).

Referring to the implementation shown in FIG. 1, the separator structures 105 may separate the electrode structures 102 from the counter-electrode structures 104. As indicated elsewhere, the implementation shown in FIG. 2 may also include separator structures. The separator structures 105 may be made of electrically insulating but ionically permeable separator material. The separator structures 105 may be adapted to electrically isolate each member of the population of electrode structures 102 from each member of the population of counter-electrode structures 104. Each separator structure 105 may include a microporous separator material that can be permeated with a non-aqueous electrolyte; for example, in one implementation, the microporous separator material includes pores having a diameter of at least 50 angstroms (50 Å), more typically in the range of about 2,500 angstroms (2,500 Å), and a porosity in the range of about 25% to about 75%, more typically in the range of about 35-55%. The separator structure 105 may have a thickness of around 4 microns (4 μm) up to around 50 microns (50 μm). However, it should be appreciated that the thickness may be less than 4 microns (4 μm) or greater than 50 microns (50 μm) in some implementations. The separator structure material may be a microporous separator material permeated with a liquid non-aqueous electrolyte, a gel, a solid electrolyte, a polymer based electrolyte, an oxide based electrolyte, and/or a ceramic based separator.

The electrode busbar 108 may be a cathodic electrode busbar when the electrode structure 102 is a cathodic type, and may be an anodic electrode busbar when the electrode structure 102 is an anodic type. In an example implementation, the anodic type busbar may be a copper busbar and the cathodic type busbar may be an aluminum busbar. In other implementations, the electrode busbar 108 and the counter-electrode busbar 110 may be any suitable conductive material or materials to allow the electrode assembly 100 to function as described herein.

The electrode structures 102 and counter-electrode structures 104 may be directly connected to the electrode busbar 108 and counter-electrode busbar 110 as shown in FIG. 1. Alternatively, as shown in FIG. 2, the electrode structures 102 and counter-electrode structures 104 may be connected to the electrode busbar 108 and counter-electrode busbar 110 via respective current limiters 206 and 207, as shown in FIG. 2. In some implementations, only the anode structures or the cathode structures may be connected via the current limiter (e.g., the electrode assembly includes either 206 or 207, but not both). In some implementations, the electrode assembly 100 and/or 200 may include a subset of either current limiters 206 and/or 207, such that some of the anode structures, some of the cathode structures, and/or some of both the anode structures and the cathode structures (but not all) are connected to the busbars 108 and 110 via current limiters 206 and/or 207. In still further implementations, two or more electrode or counter-electrode current collectors may be connected to the respective busbar via the same current limiter.

As shown in FIG. 2, each member of the population of current limiters 206 is electrically connected between a different electrode current collector 114 and the electrode busbar 108. Additionally, each member of the population of current limiters 207 is electrically connected between a different counter-electrode current collector 118 and the counter-electrode busbar 110. The current limiters 206 are configured to limit the current that may flow through the electrode current collector 114, and correspondingly through the electrode structure 102, to which it is connected. The current limiters 207 are configured to limit the current that may flow through the counter-electrode current collector 118, and correspondingly through the counter-electrode structure 104, to which it is connected. Thus, for example, if a short circuit is formed between one of the electrode current collectors 114 and one of the counter-electrode current collectors 118, the current limiters 206 and/or 207 may limit the amount of current that can flow from the other electrodes and counter electrodes of the electrode assembly and thereby limits the temperature experienced by the electrode assembly 200 and prevents a thermal runaway. Specifically, the current limiters 206 and 207 limit an amount of current that may be conducted through a unit cell during a discharge of the electrode assembly in which there is an electrical short between the electrode and counter-electrode of the unit cell to a value I, which is less than a current (sometimes referenced herein as Iₜᵣ or I_{L}) through a member of the unit cell population that would induce thermal runaway of the member of the unit cell population. The current limiters provide a soft landing for the battery in the event of a short circuit. The current limiters continuously allow a non-zero level of current to flow in the event of a short circuit, but limit that current to below a level that would trigger a thermal runaway. This current will continue to flow until the battery is discharged and the risk of thermal runaway is ended.

In some implementations, the current limiters 206 and/or 207 may be resistive current limiters. The current limiters 206 and/or 207 may have a nonzero resistance within the range of normal operating temperatures of the electrode assembly 200. In one implementation, the normal operating temperatures are between negative twenty Celsius and eighty Celsius. In other implementations, the normal operating temperatures are as low as negative forty Celsius and as high as one hundred and fifty Celsius, or any other suitable range of normal operating temperatures. The resistance may be such that the current limiters 206 and/or 207 limit the current that may pass through any unit cell and prevent the current from reaching a level that may cause catastrophic failure or any other maximum current level that is determined for other performance or abuse tolerance reasons as determined during battery design. The current limiters 206 and/or 207 may not rely on a fuse or any positive temperature coefficient (PTC) characteristic of the resistive material. That is, although the current limiters 206 and/or 207 may exhibit a PTC, a PTC is not required for the current limiters 206 and/or 207 to function as described herein. Rather, the resistance of the current limiters 206 and/or 207 in the range of normal operating temperatures of the electrode assembly 200 may be sufficient to limit the current. In some implementations, the resistance may increase or decrease (i.e., the current limiters may have a negative temperature coefficient) within the normal range of operating temperatures. The current limiters 206 and/or 207 may each be electrically in series with the electrode current collector 114 or counter-electrode current collector 118 to which they are attached. Thus, the resistance of each current limiter 206 and/or 207 and its associated electrode structure 102 or counter-electrode structure 104 may be increased by adding the resistance of the associated electrode structure 102 or counter-electrode structure 104 and the resistance of the current limiter 206 or 207 attached thereto. Adding resistance to a battery is conventionally discouraged, because the added resistance will increase the losses experienced by the battery when current is flowing into the electrode structures 102 or counter-electrode structures 104 (during charging) and out of the electrode structures or counter-electrode structures (during discharge). However, because the electrode current collectors 114 and counter-electrode current collectors 118 are all connected to the electrode busbar 108 or counter-electrode busbar 110 in parallel (electrically parallel), the increase in total resistance seen at the electrode busbar 108 or counter-electrode busbar 110 is much smaller than the resistance of each individual current limiter 206 or 207. Moreover, the resistance of the current limiters 206 and/or 207 in this disclosure is selected to be small enough to have a limited voltage drop across the current limiters 206 and/or 207 and thereby have a limited loss of power. In the example implementation, the resistance of the current limiters may be selected to have no more than a 20 mV drop across each of the current limiters 206 and/or 207 during charging or discharging at a 1 C rate to limit losses during normal operation while still protecting the battery during a short circuit.

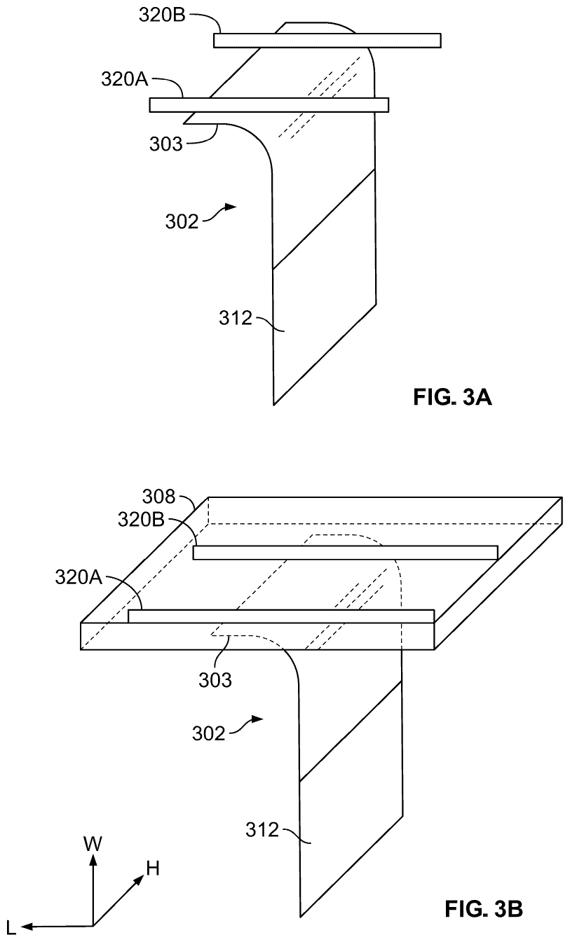

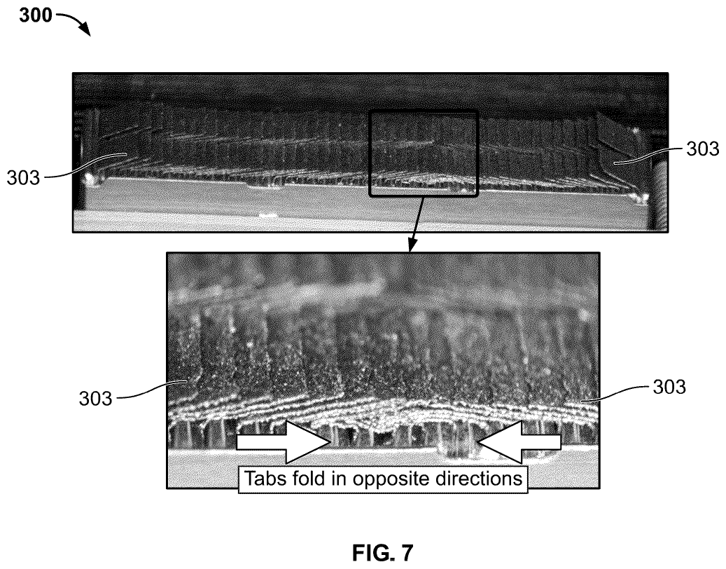

In some implementations, such as those shown in FIGS. 3A, 3B, 4A, 4B, 5, 6, and 7, the electrode structure 102 and/or counter-electrode structure 104 may be connected to the electrode busbar 108 or counter-electrode busbar 110 using an adhesive polymer. For example, as shown in FIGS. 3A and 3B, an end portion 303 of the electrode structure 302, which may also be referred to as a tab of the electrode structure 302, may be bent or folded over to provide a surface area for connection to the electrode busbar 308. This is discussed in further detail below, and shown in further detail in FIG. 7. While the implementations shown in FIGS. 3A, 3B, 4A, 4B, 5, 6, and 7 may be illustrated showing only a single electrode or single side of the battery structure (e.g., only the electrode structure connecting to the electrode busbar), the same features and functionality may also be applied with respect to the counter-electrode structure connecting to the counter-electrode busbar. In one implementation, the electrode structure is a cathode structure, and the discussion herein applies to the connection between the cathode structure and the cathode busbar.

As shown in FIGS. 3A and 3B, the end portion 303 of the electrode current collector 302 is bent to approximately a ninety degree angle. Adhesive polymer strips 320A and 320B may be applied to the end portion 303. And the electrode busbar 308 may then be positioned over the end portion 303 and affixed thereto using heat and/or pressure. The electrode busbar 308 is then attached to the end portion 303 of the electrode current collector 302 via the adhesive polymer strips 320A and 320B. While FIGS. 3A and 3B illustrate a single electrode current collector 302, it should be appreciated that many electrode current collectors may be positioned next to each other and all attached to the electrode busbar 308 via the adhesive polymer strips 320A and 320B.

The adhesive polymer strips 320A and 320B may be the same material, or may be different materials. In some implementations, the adhesive polymer may include a neat polymer, a thermoplastic adhesive, a thermoset, and/or a base polymer and a conductive filler. The neat polymer may be a polymer without any fibers or conductive filler. The thermoplastic adhesive may be a polymer adhesive that does not undergo any curing process or chemical reaction when being applied. Thermoplastic adhesives are typically solid at room temperature, and can be heated to a liquid state during application. The thermoset may be a thermosetting polymer that undergoes a chemical reaction during curing, which may be an irreversible process. The base polymer and conductive filler may be any suitable polymer with a filler material suspended therein. The conductive filler material may be one or more of an aluminum filler, a titanium filler, a titanium nitride filler, a carbon-based filler, a stainless steel filler, a noble metal filler, or mechanically agitated solders. A shape of the conductive filler may be one or more of spheres, flakes, fibers, hollow coated particles, solid coated particles, or a conductive mesh.

Selection of the adhesive polymer material and configuration (e.g., whether conductive fillers are included, and/or the material and shape of the conductive fillers), may be based on electrolyte compatibility, adhesion, and/or temperature stability. For example, certain polymers have better compatibility with the electrolyte material used in the battery, meaning that they do not degrade or change their properties as much over time. Certain polymers also provide greater adhesion to metals, plastics, or other required battery cell components. Furthermore, certain polymers exhibit reliable performance and structural integrity over the temperature range at which the battery is expected to operate. Two such polymers may include Primacor 3701, which is an ethylene acrylic acid ionomer, and Primacor 59801, which is an ethylene acrylic acid copolymer.

The adhesive polymer strips 320A and 320B may be an adhesive polymer, copolymer, or blend, and in some implementations may have a conductive material suspended therein. In some implementations, the adhesive polymer may be substantially nonconducting (e.g., insulating). In implementations where there are conductive fillers, the base polymer may be substantially non-conducting prior to suspension of the conductive fillers therein. Generally, desirable polymers may be any that are (a) stable in the environment of a Li-ion battery cell (i.e. do not dissolve in the electrolytes, react with electrolyte components or any other battery components, or undergo redox chemistry or reactions that degrade the material during cell operation) and (b) have melting points above the typical working temperature of a Li-ion battery. Flexibility in the polymer is another desirable trait. Therefore, materials or blends of materials with some elasticity and particularly with a glass transition temperature (Tg) above 0° C. may be used. In some implementations, the polymer used for the adhesive polymer strips 320A and 320B may be a polymer blend with at least one component with a high elasticity (measured by standard methods such as modulus and/or elongation to break). In some implementations, the polymer is a flowable adhesive polymer. In such implementations, the polymer should have flow properties that allow for melt processing, including compounding of conductive aids and other additives if desired, film/sheet preparation by standard methods such as cast film, blown film, and calendering. Melting points of the polymer(s) used for the adhesive polymer strips 320A and 320B may allow for melt processing and bonding to the cell via a melt press or related technique, and should be above the typical working temperature range of the cell. Polymers that melt from 40° C. to 300° C. may be used for the adhesive polymer strips 320A and 320B.

Example suitable polymers or copolymers for use in the adhesive polymer strips 320A and 320B may include EAA (ethylene-co-acrylic acid) and EMAA (ethylene-co-methacrylic acid), ionomers of the EAA or EMAA, polyethylene and copolymers thereof (such as, ethylene/1-octene, ethylene/1-hexene, ethylene/1-butene, and ethylene/propylene copolymers), polypropylene and copolymers thereof, a functionalized or derivatized polyethylene or polypropylene (such as, maleic anhydride grafted materials), or the like.

In some implementations, the adhesive polymer strips 320A and/or 320B may include a base polymer and a conductive filler. The conductive filler (or conductive material) suspended in the base polymer to form the conductive adhesive may be any powder, fiber, particle, or the like that confers the desired conductivity to the base polymer after compounding with the polymer. Most desirable are materials that confer the desired conductivity at lower loadings because high loading of additives may change the properties of the polymer blend in undesirable ways. For example, high loadings may lead to a significant decrease in melt processability, impacting the ability to manufacture films or sheets of conductive polymer using conventional equipment. In addition, conductive additives are often expensive materials, and lower loadings are desirable to maintain a lower cost for manufacturing.

As noted above, the conductive filler material may be one or more of aluminum, titanium, titanium nitride, carbon-based materials, stainless steel, a noble metal, or mechanically agitated solders. Other suitable materials may include, for example, conductive carbon black, metal coated carbon fiber, carbon nanotubes, nickel, copper, gold, silver, tin, titanium, graphite, molybdenum, platinum, chromium, aluminum, or any other metallic particles, including alloys or blends thereof. Loading of conductive material into the polymer to form the adhesive polymer strips may be in the range of 1% to 50% conductive material (as weight percent of the total mixture), between 2% to 40%, or between 3% to 30%.

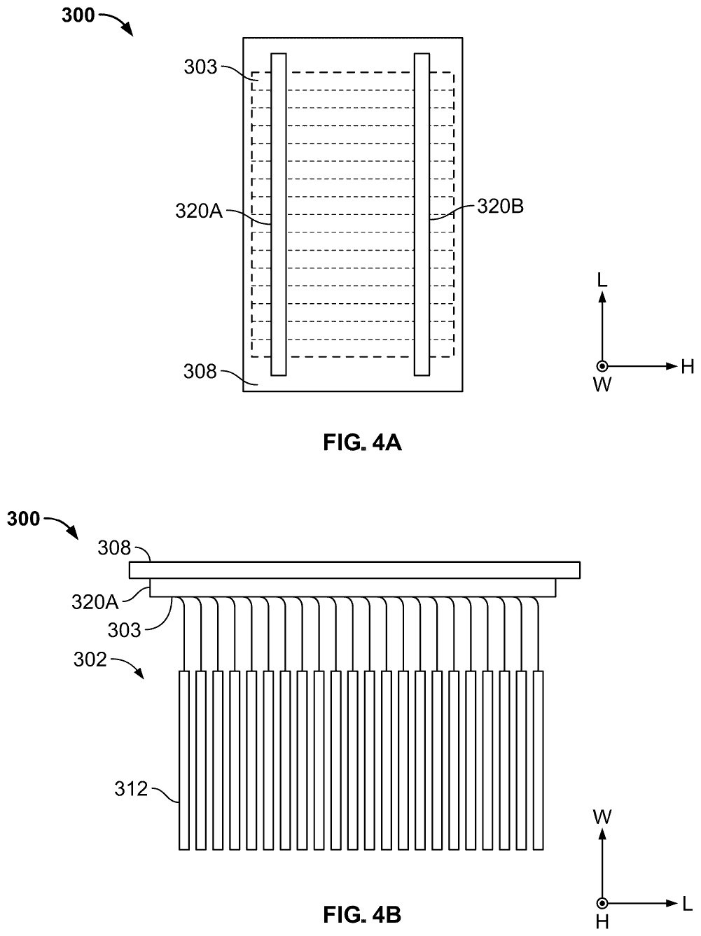

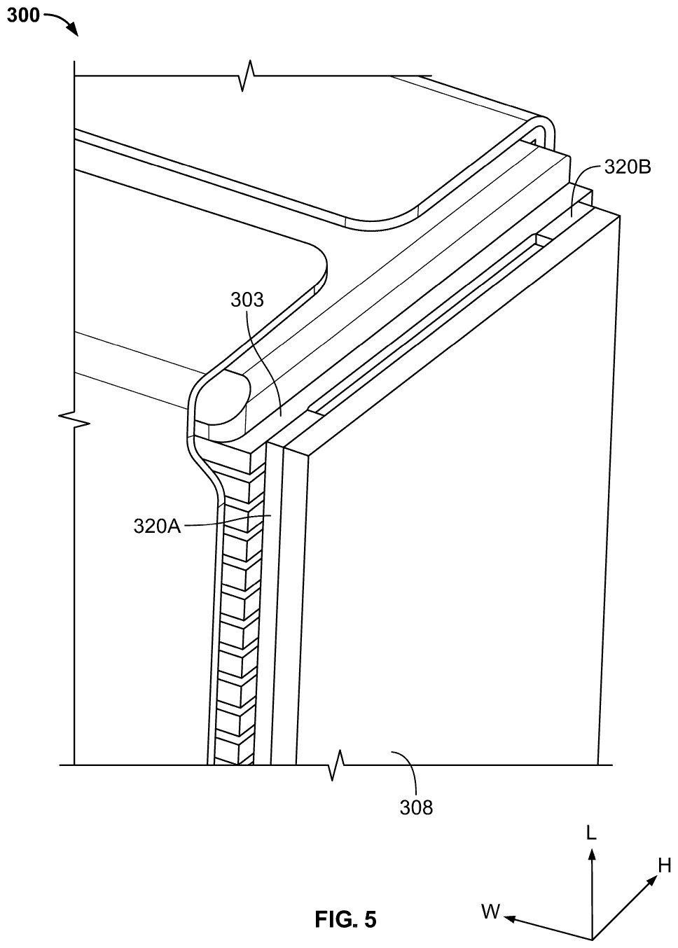

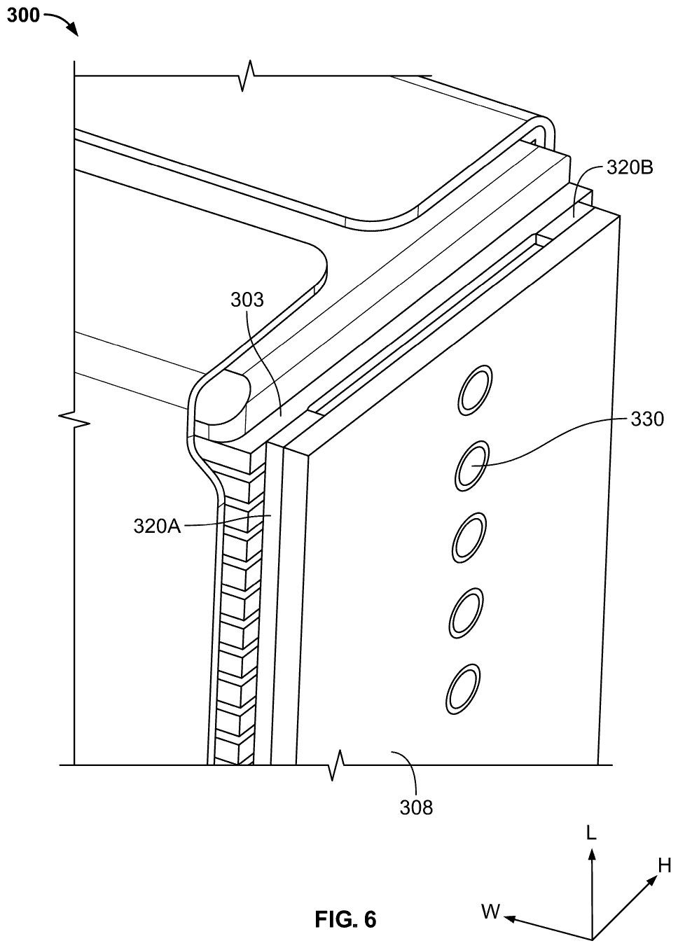

As shown in FIGS. 3B, 4A, 5, and 6, the adhesive polymer strips 320A and 320B may be positioned such that they extend along the length L of the electrode assembly 300 in the stacking direction. In some implementations, such as are shown in FIGS. 5 and 6, the adhesive polymer strips 320A and 320B may be positioned at the edges of the end portions 303 in the height (H) direction (e.g., along the outer edges of the end portions 303). In other implementations, such as are shown in FIGS. 3A, 3B, and 4A, the adhesive polymer strips 320A and 320B may be positioned inset from the edges of the end portions 303 in the height (H) direction.

In some implementations, each adhesive polymer strip may extend the full length of the electrode assembly 300 in the stacking direction (L). In other implementations, each adhesive polymer strip may extend in the stacking direction only as far as to match the length of the end portions 303 of the electrode assembly. In some implementations, each adhesive polymer strip may be slightly longer than the electrode assembly in the stacking direction (L), such as in FIGS. 4A and 4B. In some implementations, one or more of the adhesive polymer strips may extend only partially along the length of the electrode assembly in the stacking direction (L). In some implementations, two or more of the adhesive polymer strips may be offset from each other. These offset strips, when combined, may extend the full length of the electrode assembly in the stacking direction (L). For instance, a first strip may extend from a first end of the electrode assembly in the stacking direction L to a halfway point of the assembly. A second strip, offset from the first strip in the height direction (H) (e.g., either closer to or farther from the edge of the end portion 303) may extend from the halfway point to a second end of the electrode assembly. When combined, the first strip and the second strip provide full coverage of the electrode assembly in the stacking direction (L).

In the illustrated implementations, the electrode assembly 300 may include two adhesive polymer strips, each extending in the stacking direction (L), and spaced apart from each other in the height direction (H). In other implementations, there may be a single adhesive polymer strip, or there may be three or more adhesive polymer strips. For examples where there are two or more adhesive polymer strips, they may be spaced apart in the height direction (H) such that there is no overlap, or they may be positioned such that there is some overlap. Additionally, the adhesive polymer strips may be positioned such that they are parallel to each other, or may be at an angle with respect to each other. Further, the adhesive polymer strips may be positioned such that they are parallel to the stacking direction (L), or are at an angle with respect to the stacking direction (L). It should be appreciated that the adhesive polymer strips may be positioned with any suitable configuration or combination of strip placement, length, orientation, and coverage of the end portions of the electrode current collectors. In the illustrated implementations, the thickness of the adhesive polymer strips in the height direction (H) may be approximately 10% of the height of the electrode assembly. However, it should be appreciated that the thickness may be any suitable thickness that is smaller or larger than 10% of the height of the electrode assembly. In some examples, the thickness of the adhesive polymer may be approximately 100 microns (100 μm), while in other examples the thickness may be as low as 2 microns (2 μm), or as high as 500 microns (500 μm) or more. The thickness may depend on one or more factors, such as material cost, pressure required during application, resulting mechanical and/or electrical connection quality, and more.

In some implementations, in addition to the adhesive polymer strips 320A and 320B, the end portions 303 of the electrode structures 302 may be affixed to the electrode busbar 308 via welding. FIG. 6 illustrates that there may be adhesive polymer strips 320A and 320B positioned at the edges of the end portions 303, and there may be welds 330 positioned at the middle of the end portions 303 connecting the end portions 303 to the electrode busbar 308. In some implementations, the welding 330 may be continuous along the length of the electrode busbar 308 in the stacking direction (L), while in other implementations, the welding 330 may be only in certain spots, or some other discontinuous pattern. Furthermore, the welding 330 may be positioned along the center line of the electrode busbar 308 (as shown in FIG. 6), or may be positioned offset to one side or the other in the height direction (H). Additionally, there may be one, two, or more welding lines, which may be spaced apart from each other, and/or may mirror the positioning of the adhesive polymer strips 320A and 320B.

FIG. 0.7 illustrates enlarged side views of the end portions 303 of a plurality of electrode structures, before the adhesive polymer strips or the electrode busbar have been applied. As illustrated, first and second subsets of the end portions 303 are folded over or bent in opposite directions toward each other. Alternatively, in some implementations, each end portion 303 may be bent in the same direction, as illustrated in FIG. 4B where each end portion is bent to the left.

The implementations illustrated in FIGS. 3A, 3B, 4A, 4B, 5, 6, and 7 each include the electrode structures connected to the electrode busbar without a current limiter positioned in between. However, in some implementations, the end portions of the electrode structures may act as current limiters, may be made from the material of the current limiters described herein, and/or may be connected to current limiters. In these cases, the current limiters may be affixed to the electrode busbar via the adhesive polymer strips in a manner similar or identical to that described herein. For instance, the descriptions herein that refer to affixing the end portions of the electrode structures to the electrode busbar via the adhesive polymer strips may instead be understood as referring to affixing the current limiters to the electrode busbar via the adhesive polymer strips, wherein the current limiters are also affixed to the end portions of the electrode structures.

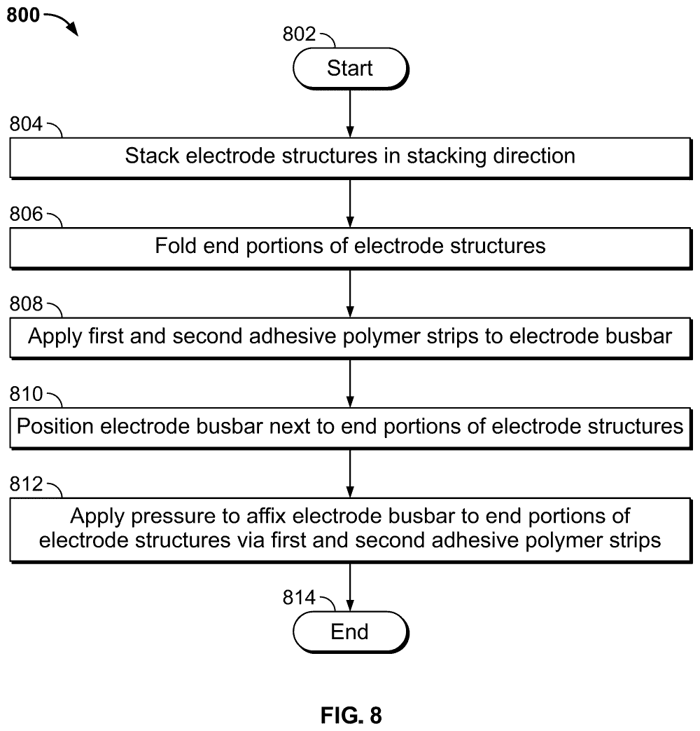

FIG. 8 is a flowchart of an illustrative process 800 for affixing an electrode busbar to the end portions of a plurality of electrode structures, in accordance with some implementations of the disclosure. Process 800 may be illustrative of the techniques that may be carried out by an assembly or manufacturing system for secondary batteries described herein. Although the processes are illustrated and described as a sequence of actions, it is contemplated that various implementations of the process may be performed in any order or combination, need not include all the illustrated actions, and/or may include additional actions not shown in FIG. 8.

At 802, the process of affixing the electrode busbar to the electrode structure begins. At 804, the process 800 includes stacking the electrode structures in the stacking direction. As illustrated with respect to FIGS. 1-7, the electrode structures may be arranged in an interdigitated structure, wherein the electrode structures and counter-electrode structures are stacked in an alternating manner. The electrode structures and counter-electrode structures may be oriented such that end portions of each structure extend outward in the width direction (W), as illustrated in FIGS. 1-6.

At 806, the process 800 includes folding over the end portions of the electrode structures. The end portions may extend outward in the width direction (W), and may be folded over such that they overlap each other, as shown in FIG. 7. In some implementations, each of the end portions may be folded over in the same direction (e.g., as shown in FIG. 4B). In other implementations, the end portions may be folded over toward a middle of the battery structure (e.g., as shown in FIG. 7). In still other implementations, the end portions may be folded over away from the middle of the battery structure, and/or subsets of the end portions may be folded in different directions (e.g., toward the middle, away from the middle, etc.).

At 808, the process 800 includes applying the first adhesive polymer strip and the second adhesive polymer strip to the electrode busbar. As noted above, the adhesive polymer strips may be thermoplastic, thermoset, and/or may be a neat polymer or a base polymer with conductive filler suspended therein. Process 800 may also include heating the adhesive polymer to allow the polymer to flow during application. In some implementations, rather applying the adhesive polymer to the electrode busbar, the process may instead include applying the adhesive polymer to the end portions of the electrode structures.

At 810, the process 800 includes positioning the electrode busbar next to the end portions of the electrode structures. This may include aligning the electrode busbar with the end portions of the electrode structures, as shown in FIGS. 3B, 4A, 4B, 5, and 6.

At 812, the process 800 includes applying pressure to the electrode busbar to affix the electrode busbar to the end portions of the electrode structures via the first and second adhesive polymer strips. In some implementations, the pressure is applied uniformly to the surface of the electrode busbar. The pressure forcing the electrode busbar into the end portions of the electrode structures causes the adhesive polymer strips to compress, thereby increasing the contact surface with the end portions of electrode structures and the electrode busbar. Additionally, the pressure may cause the adhesive polymer strips to expand sideways in the height (H) direction, thereby increasing the contact area between the end portions of the electrode structures, the adhesive polymer strips, and the electrode busbar. Furthermore, in some implementations, the pressure on the electrode busbar may cause the adhesive polymer to expand outward toward the outer edges of the end portions in height (H) direction, as well as to expand inward toward a center of the end portions.

In some implementations, the pressure may be applied to a middle of the electrode busbar in the height (H) direction, such that the pressure is applied in a line extending in the stacking direction (L) between the adhesive polymer strips. This non-uniform pressure may cause a deflection of the middle portion of electrode busbar, such that the outer edges of the electrode busbar that are positioned over the adhesive polymer strip may deflect upward, while the middle portion receiving the pressure bends down to contact the end portions of electrode structures. This may reduce the amount of adhesive polymer that expands sideways or oozes out from between the electrode busbar and the end portions of the electrode structures. The process 800 may then end at 814.

In some implementations, the process 800 may also include welding the electrode busbar to the end portions of the electrode structures. FIG. 6, illustrates an implementation wherein the centerline of the electrode busbar along the stacking direction (L) is welded to the end portions of the electrode structures. In other implementations, the welding may be performed along a different line, in a different shape, or in a different orientation with respect to the electrode busbar.

The process discussed above is intended to be illustrative and not limiting. One skilled in the art would appreciate that the actions described with respect to the process discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present invention includes. Furthermore, it should be noted that the features and limitations described in any one implementation may be applied to any other implementation herein, and flowcharts or examples relating to one implementation may be combined with any other implementation in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. An electrode assembly comprising:
a plurality of unit cells stacked in a stacking direction, each of the unit cells comprising an anode structure, a separator structure, and a cathode structure, wherein the cathode structure of each unit cell comprises:
a cathode current collector; and
a cathode active material layer, wherein (1) the cathode structure extends in a longitudinal direction perpendicular to the stacking direction, and (2) an end portion of the cathode current collector extends beyond the cathode active material and the separator structure in the longitudinal direction;
a first adhesive polymer strip attached to the end portion of the cathode current collector of each unit cell of the plurality of unit cells;
a second adhesive polymer strip attached to the end portion of the cathode current collector of each unit cell of the plurality of unit cells, wherein the first adhesive polymer strip and the second adhesive polymer strip are separated in a third direction perpendicular to both the stacking direction and the longitudinal direction; and
a cathode busbar attached to the end portions of the cathode current collectors through the first adhesive polymer strip and the second adhesive polymer strip.

2. The electrode assembly of claim 1, wherein the first adhesive polymer strip and the second adhesive polymer strip each comprise a neat polymer.

3. The electrode assembly of claim 1, wherein the first adhesive polymer strip and the second adhesive polymer strip each comprise a thermoplastic adhesive.

4. The electrode assembly of claim 1, wherein the first adhesive polymer strip and the second adhesive polymer strip each comprise a thermoset.

5. The electrode assembly of claim 1, wherein middle sections of the end portions of the current collectors are attached directly to the cathode busbar, the middle sections extending between the first adhesive polymer strip and the second adhesive polymer strip.

6. The electrode assembly of claim 5, wherein the middle sections of the end portions of the current collectors are welded to the cathode busbar.

7. The electrode assembly of claim 1, wherein the first adhesive polymer strip and the second adhesive polymer strip are parallel and extend in the stacking direction.

8. The electrode assembly of claim 1, wherein the first adhesive polymer strip and the second adhesive polymer strip each comprises a base polymer and a conductive filler.

9. The electrode assembly of claim 8, wherein the conductive filler comprises one of an aluminum filler, a titanium filler, a titanium nitride filler, a carbon-based filler, a stainless steel filler, or a noble metal filler.

10. The electrode assembly of claim 8, wherein a shape of the conductive filler comprises one of spheres, flakes, fibers, hollow coated particles, solid coated particles, or a conductive mesh.

11. A method of assembling an electrode assembly comprising:
stacking a plurality of unit cells in a stacking direction, each of the unit cells comprising an anode structure, a separator structure, and a cathode structure, wherein the cathode structure of each unit cell comprises:
a cathode current collector; and
a cathode active material layer, wherein (1) the cathode structure extends in a longitudinal direction perpendicular to the stacking direction, and (2) an end portion of the cathode current collector extends beyond the cathode active material and the separator structure in the longitudinal direction;
attaching a first adhesive polymer strip to the end portion of the cathode current collector of each unit cell of the plurality of unit cells;
attaching a second adhesive polymer strip to the end portion of the cathode current collector of each unit cell of the plurality of unit cells, wherein the first adhesive polymer strip and the second adhesive polymer strip are separated in a third direction perpendicular to both the stacking direction and the longitudinal direction; and
attaching a cathode busbar to the end portions of the cathode current collectors through the first adhesive polymer strip and the second adhesive polymer strip.

12. The method of claim 11, wherein the first adhesive polymer strip and the second adhesive polymer strip each comprise a neat polymer.

13. The method of claim 11, wherein the first adhesive polymer strip and the second adhesive polymer strip each comprise a thermoplastic adhesive.

14. The method of claim 11, wherein the first adhesive polymer strip and the second adhesive polymer strip each comprise a thermoset.

15. The method of claim 11, further comprising:
attaching middle sections of the end portions of the current collectors directly to the cathode busbar, the middle sections extending between the first adhesive polymer strip and the second adhesive polymer strip.

16. The method of claim 15, further comprising:
welding the middle section of the end portions of the current collectors to the cathode busbar.

17. The method of claim 11, wherein the first adhesive polymer strip and the second adhesive polymer strip are parallel and extend in the stacking direction.

18. The method of claim 11, wherein the first adhesive polymer strip and the second adhesive polymer strip each comprises a base polymer and a conductive filler, and wherein the conductive filler comprises one of an aluminum filler, a titanium filler, a titanium nitride filler, a carbon-based filler, a stainless steel filler, or a noble metal filler.

19. The method of claim 18, wherein a shape of the conductive filler comprises one of spheres, flakes, fibers, hollow coated particles, solid coated particles, or a conductive mesh.

20. A secondary battery comprising a battery enclosure, an electrode assembly, and an electrolyte within the battery enclosure, wherein the electrode assembly comprises:
a plurality of unit cells stacked in a stacking direction, each of the unit cells comprising an anode structure, a separator structure, and a cathode structure, wherein the cathode structure of each unit cell comprises:
a cathode current collector; and
a cathode active material layer, wherein (1) the cathode structure extends in a longitudinal direction perpendicular to the stacking direction, and (2) an end portion of the cathode current collector extends beyond the cathode active material and the separator structure in the longitudinal direction;
a first adhesive polymer strip attached to the end portion of the cathode current collector of each unit cell of the plurality of unit cells;
a second adhesive polymer strip attached to the end portion of the cathode current collector of each unit cell of the plurality of unit cells, wherein the first adhesive polymer strip and the second adhesive polymer strip are separated in a third direction perpendicular to both the stacking direction and the longitudinal direction; and
a cathode busbar attached to the end portions of the cathode current collectors through the first adhesive polymer strip and the second adhesive polymer strip.
